(19) United States
(12) Patent Application Publication
(10) Pub. No.: US 2005/0189753 A1
(43) Pub. Date: Sep. 1, 2005

(54) Gas generator

(76) Inventors: Kazuhiro Kato, Shisou-gun (JP); Shingo Oda, Himeji-shi (JP); Hirotoshi Niwa, Himeji-shi (JP); Yuji Kurihara, Osaka (JP); Mikio Yabuta, Himeji-shi (JP)

Correspondence Address: BIRCH STEWART KOLASCH & BIRCH, PO BOX 747, FALLS CHURCH, VA, 22040-0747, US

(21) Appl. No.: 11/053,834

(22) Filed: Feb. 10, 2005

Related U.S. Application Data
(60) Provisional application No. 60/545,140, filed on Feb. 18, 2004.

(30) Foreign Application Priority Data
Feb. 10, 2004 (JP) 2004-33828

(51) Int. Cl. B60R 21/28

(52) U.S. Cl. 280/741

(57) ABSTRACT

The present invention provides a small gas generator which is capable of preventing a cup-like member or fragments thereof from being scattered, even when gas is discharged in the radial direction of the gas generator. The gas generator comprises a cup-like member having a cylindrical form with a bottom, which is integrated with an igniter assembly at a joining portion. The thickness of the joining portion is greater than the thickness of a side wall portion of the cup-like member.

### TECHNICAL FIELD

The present invention relates to a gas generator disposed in a vehicle or the like, which is activated by an impact or the like to generate gas, and more particularly to a small-sized gas generator such as a gas generator for a pretensioner.

### BACKGROUND ART

Various vehicles such as automobiles are provided with seat belts to protect passengers from an impact occurring during a collision. In recent years, seat belts comprising a pretensioner mechanism for protecting the passenger by tightening the seat belt have been developed.

Generally, such a seat belt pretensioner is constituted by a mechanism for tightening the seat belt and a gas generator for generating gas to activate the mechanism. A small gas generator with a small overall volume (a so-called micro gas generator, abbreviated to MGG) is used as the gas generator. This small gas generator is typically constituted by an activation starting device such as an igniter, and a gas generating agent to be ignited by the activation starting device to generate gas through combustion. The small gas generator is typically formed by fixing an open end of a cup-like member formed into a cylinder with a bottom to a collar member for holding the igniter such that the gas generating agent charged into the cup-like member contacts the igniter.

A small-sized gas generator that can be used favorably in a pretensioner is disclosed in WO-A No. 95/11421, for example. In the small gas generator disclosed in this publication, the periphery of a collar which holds an igniter is held by crimping the tip end of an open end side of a cup-like member accommodating a gas generating agent, and thus the igniter collar member and the cup-like member are integrated. A weakest portion is provided on the bottom surface of the cup-like member accommodating the gas generating agent for discharging a gas generated by combustion of the gas generating agent.

In other words, conventional gas generators provided for use in pretensioners are constituted to discharge gas from the bottom surface of the cup-like member in the axial direction of the gas generator, as illustrated in WO-A No. 95/11421.

### DISCLOSURE OF THE INVENTION

However, in a gas generator such as that disclosed in WO-A No. 95/11421, which ejects gas in a single direction (i.e. the axial direction), it is difficult to discharge gas in another desired direction, and if a malfunction were to occur before the gas generator was fixed, propulsion would be generated in the gas generator by the ejected gas, propelling the gas generator into flight during the malfunction. It is therefore difficult to secure manufacturing safety with such a gas generator. Even after the gas generator is attached to the pretensioner, the assembly condition in the pretensioner has to be substantial to ensure that the activated gas generator is not propelled into flight or dislocated. In other words, with a constitution in which gas is ejected in a concentrated fashion in a single direction, the assembly part is easily strained, and hence the structure of this part must be made substantial.

It is desirable that a small gas generator which can be used in a pretensioner or the like be capable of discharging gas in an arbitrary predetermined direction in accordance with the demands of its disposal state and the like. In other words, when the gas generator is activated, gas is preferably discharged in such a manner that no large propulsive force is generated in any single direction. Moreover, the gas generator is preferably able to respond to the demands of its disposal state and so on, and also to requirements such as offsetting the gas ejection direction peripherally to a certain extent.

However, conventional small gas generators are formed on the premise that gas is discharged exclusively in the axial direction, and hence if forced attempts are made to discharge the gas in the radial direction (by forming fissures in the peripheral wall portion of the cup-like member), the edge part at the tip end of the cup-like member (the part which holds the peripheral surface of the collar member by being crimped thereto) also becomes easily breakable, and as a result, the crimped part is likely to dislocate. If the crimped part were to dislocate, the cup-like member or fragments thereof, having separated from the igniter collar member, may block the gas discharge port to a certain extent, and in such a case, it would become impossible to obtain a sufficient effect. Furthermore, if the gas ejection direction is offset peripherally to a certain extent, the load applied to the edge portion at the tip end of the cup-like member becomes biased, making the part at which the edge part of the tip end is crimped likely to dislocate.

The present invention is to solve the problems existing in a conventional small gas generator that can be used in a pretensioner, and an object of the present invention is to provide a small gas generator with a suppressed overall volume, which is capable of preventing a cup-like member or fragments thereof from being scattered even when gas produced by an operation is discharged in the radial direction of the gas generator, and in which propulsion is not generated by the discharged gas.

To solve the problems described above, the present invention provides a gas generator in which the thickness of a joining portion of a cup-like member accommodating a gas generating agent to be joined to an igniter collar member is increased such that when the gas generator is activated, the cup-like member, or fragments thereof, is prevented from dislocating from the igniter collar member.

More specifically, the present invention provides a gas generator comprising an igniter assembly in which an igniter functioning as an activation starting means is held by an igniter collar member, a gas generating agent which generates gas when ignited by an activation of the igniter, and a cup-like member in a cylindrical form with one closed end, in which the gas generating agent is accommodated, wherein a joining portion which is joined to the igniter collar member in the igniter assembly is provided on an open side end portion of the cup-like member, and the cup-like member and igniter assembly are integrated by this joining portion, and the thickness of the joining portion provided on the cup-like member is greater than the thickness of a side wall portion of the cup-like member.

In the gas generator of the present invention, the joining portion formed on the open side end portion of the cup-like member has to be thicker than the other portions and wall surfaces constituting the cup-like member, and particularly than the side wall portion. By forming the joining portion to be thicker than the side wall portion, the strength of the joining portion is increased, and hence even when the gas that is generated by combustion of the gas generating agent causes the internal pressure of the cup-like member to rise such that fissures are formed in the cup-like member, these fissures do not extend to the joining portion. As a result, even when the gas that is generated by an activation is discharged in an arbitrary direction, particularly in the radial direction of the gas generator, the joining condition between the cup-like member and the igniter collar member is maintained after the activation, and hence the cup-like member or fragments thereof can be prevented from flying.

The portion which is to become the joining portion may be formed with a greater thickness when press-molding the cup-like member, for example, or the portion which is to become the joining portion may be reinforced by or adhered to another member or the like after press-molding the cup-like member at a constant thickness.

The aforementioned open side end portion of the cup-like member typically refers to the end portion of the side on which an igniter, serving as an activation starting member of the gas generator, or an igniter assembly comprising the igniter is to be assembled. The joining portion is the portion on this open side end portion, which is joined to the igniter collar member for holding the igniter, and portions in the vicinity thereof. In other words, when the cup-like member and the igniter collar member are joined in point, line, and surface contact, this encompasses not only the contacting portions, but also the vicinity of these portions.

The joining portion may be formed as well-known means (a constitution and materials) for joining metals to each other. For example, the joining portion may be realized as a screw groove portion in a case where the open end portion of the cup-like member is screwed to the igniter collar member, or may be realized as a flange portion in a case where a flange portion formed on either member is engaged to an appropriate location on the other member or fixed to an appropriate location on the other member by crimping.

It is particularly preferable that in the present invention, the joining portion be a flange portion formed by bending the open side end portion of the cup-like member. This is so that the open end portion of the cup-like member and the igniter collar member can be joined easily and securely. It is also preferable that the flange portion be fixed to the igniter collar member in the igniter assembly by crimping. For example, the flange portion may be fixed to the igniter collar member by crimping the peripheral edge or the like of the flange portion to an appropriate location on the igniter collar member, or by crimping an appropriate location on the igniter collar member so that the flange portion formed on the cup-like member side is held thereby. Alternatively, the flange portion formed on the cup-like member and the collar member may be fixed together by crimping using a third member. When the two members are fixed together by crimping, the fixing operation can be performed safely without heat and so on, and the fixing operation can also be performed easily.

Particularly in the gas generator of the present invention, a fragile portion, formed so as to be the weakest part of the wall portion of the cup-like member in relation to the pressure and heat that are generated in the interior of the cup-like member, is preferably provided in the sidewall portion of the cup-like member as a part which fissures first to ensure that the side wall portion side fissures first of the parts of the cup-like member which receive the pressure of the gas generated by combustion of the gas generating agent, or in other words the side wall portion and base surface (closed side end surface). This fragile portion may be formed by forming a notch in an appropriate location in the side wall surface, reducing the thickness of the side wall surface within a fixed range, or forming an opening and blocking the opening with a member which breaks or disappears easily. The fragile portion is preferably formed as a notch in the sidewall portion. The notch may be formed to extend in the axial direction of the cup-like member, or may be formed intermittently or in a zigzag pattern in the circumferential direction of the cup-like member. Moreover, the notch may be formed in either the inner peripheral surface or the outer peripheral surface of the side wall portion, or in both. When the fragile portion is formed as a notch extending in the axial direction of the cup-like member, fissures can be formed reliably in the side wall portion of the cup-like member alone, and hence this is particularly preferable.

Since the fragile portion serves as the part from which gas is discharged during an operation, the fragile portions is preferably provided equally in the circumferential direction of the cup-like member. More specifically, when the number of formed fragile portions is set at n, the fragile portions are preferably provided to satisfy a relationship in which the interior angle of adjacent fragile portions is 360 degrees/n. Furthermore, the gas discharge direction and discharge amount are preferably adjusted such that the resultant force of the propulsion (vector) generated by the discharged gas reaches substantially zero. By forming the fragile portions in this manner, the propulsion generated by the ejected gas is cancelled out, and hence the gas generator itself can be prevented from being propelled into flight. Moreover, a fixing means for fixing the gas generator to a pretensioner or the like can be simplified since there is no need to resist this propulsion. However, when the formed gas generator is fixed securely to the pretensioner such that the propulsion generated by the gas discharged during an operation is suppressed and the gas generator is disposed to be able to resist this propulsion, the fragile portions may be provided to be maldistributed on one part in the circumferential direction of the cup-like member. By unevenly distributing the fragile portions on one part in the circumferential direction of the cup-like member, more gas can be discharged in the direction which the fragile portions face, which is particularly preferable.

Particularly in the gas generator of the present invention, the thickness of the joining portion provided on the cup-like member is preferably at least 1.3 times, and more preferably at least 1.5 times, the thickness of the side wall portion of the cup-like member. In so doing, breakage and fissuring in the flange part is prevented even more reliably. Further, the thickness of the side wall portion of the cup-like member is preferably set to between 0.2 and 1.5 mm, and the thickness of the joining portion is preferably set to between 0.4 and 3.0 mm.

According to the gas generator of the present invention, a cup-like member or fragments thereof can be prevented from flying even when gas that is generated by an activation of the gas generator is discharged in the radial direction of the gas generator. Particularly in this gas generator, the orientation in which the gas is discharged cancels out the propulsion that is generated through discharge of the gas, and hence a phenomenon whereby the gas generator itself is propelled into flight during an operation can be eliminated, enabling an improvement in safety during manufacture or assembly.

The cup-like member which accommodates a gas generating agent is joined directly to an igniter collar, and hence the overall volume of the gas generator can be suppressed to form a small gas generator which can be used favorably in a pretensioner.

### BRIEF DESCRIPTION OF THE DRAWINGS

FIG. 1(A) is an axial sectional view of a small gas generator according to an embodiment of the present invention, and FIG. 1(B) is a side view showing the external appearance of this gas generator.

FIG. 2 is a side view showing a cup-like member after the gas generator has been activated.

FIG. 3 is a schematic view showing a gas generator in a comparative aspect.

### DESCRIPTION OF NUMERALS

1 gas generator
10 igniter collar member
11 tip end portion
12 bulging portion
13 protruding portion
20 cup-like member
21 open side end portion
22 flange portion
23 side wall of cup-like member
24 slit portion
25 base portion of cup-like member
30 igniter
31 electroconductive pin
40 igniter assembly

### PREFERRED EMBODIMENT OF THE INVENTION

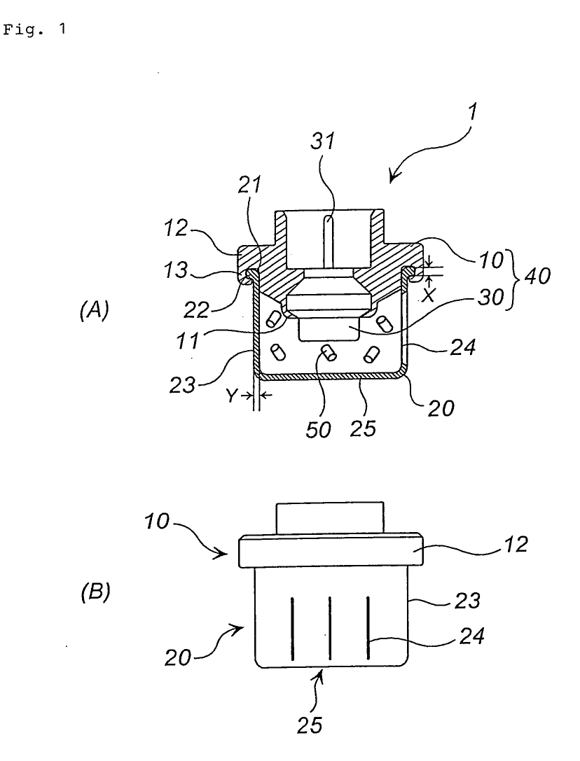

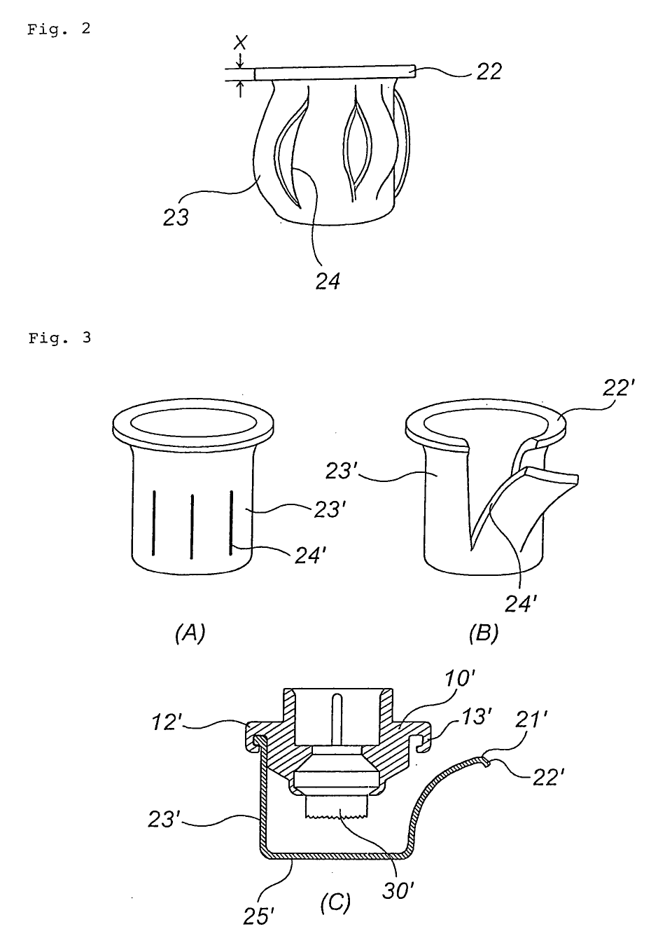

An embodiment of the present invention will be described below using the drawings. FIG. 1 shows a small-sized gas generator 1 according to this embodiment, 1(A) being an axial sectional view thereof, and 1(B) being a side view showing the external appearance thereof. FIG. 2 is a side view of a cup-like member 20 after the gas generator 1 of this embodiment has been activated, and FIG. 3 is a schematic view showing a comparative aspect, which is beneficial for understanding the effects of the present invention.

As shown in FIG. 1(A), the gas generator 1 in this embodiment comprises an igniter assembly 40 in which an igniter 30 activated upon reception of an activation signal is held by a metallic igniter collar member 10, a gas generating agent 50 disposed in contact with the igniter assembly 40, and a cup-like member 20 in the form of a cylinder with a bottom which accommodates the gas generating agent 50 and is joined to the igniter collar member 10.

In the aspect shown in FIG. 1, the igniter assembly 40 may be formed such that the electric igniter 30 is disposed inside the metallic igniter collar member 10 and the igniter 30 is integrated with the collar member 10 by crimping a tip end portion 11 of the part of the collar member which holds the igniter, or may be formed such that a base portion (a basic constitutional part) of the igniter comprising a electroconductive pin 31 or a priming (not shown) is disposed in the center of the igniter collar member 10 and a resin material is injected between the base portion of the igniter 30 and the igniter collar member 10.

In this embodiment, a bulging portion 12 protruding radially outward in the part near the axial center is formed on the outer peripheral surface of the igniter collar member 10, and an outward flange portion 22 is formed on an open side end portion 21 (the upper end portion in FIG. 1) of the cup-like member 20 formed into a cylinder with a bottom. By abutting the outward flange portion 22 formed on the cup-like member 20 against the bulging portion 12 of the igniter collar member 10 and crimping a protruding portion 13 formed on the outer periphery of the bulging portion 12, the flange portion 22 of the cup-like member 20 is held by the bulging portion 12 and the crimped protruding portion 13 of the igniter collar member 10 such that the cup-like member 20 and the igniter assembly 40 (or the igniter collar member 10) are integrated. In this state, the flange portion 22 provided on the cup-like member 20 corresponds to a joining portion of the present invention.

The flange portion 22 functioning as a joining portion is formed on the cup-like member 20 such that a thickness X thereof is greater than a thickness Y of a wall portion of the part which defines the accommodating space of the gas generating agent 50, and particularly of a side wall 23 portion. In so doing, even when fissures are formed in part of the cup-like member 20 by the pressure or flame produced in the internal space of the cup-like member 20, the fissures do not reach the flange portion 22, and therefore the joining condition between the cup-like member 20 and the igniter assembly 40 (or the igniter collar member 10) is maintained even after the gas generator 1 is activated, thus enabling a desirable operation performance.

Particularly in the gas generator 1 in this embodiment, a slit 24 formed with a less thickness than the other parts of the side wall 23 is provided in the side wall 23 of the cup-like member 20. This slit portion 24 is fissured by the pressure or flame inside the cup-like member 20 before the other parts, and hence corresponds to the aforementioned fragile portion. In FIG. 1, the slit portion 24 does not penetrate the side wall 23, but is formed such that the inner peripheral side of the cup-like member 20 is closed. In this embodiment, the slit portion 24 is formed to extend in the axial direction of the gas generator 1, and plural slit portions 24 are formed in the side wall 23 portion of the cup-like member 20 to distribute unevenly in a certain part. As shown in FIG. 1, when a fragile portion such as the slit portion 24 is provided, the slit portion 24 in the cup-like member 20 fissures first. Therefore, the ejection direction of the gas that is generated by an activation can be set optionally, and the portions of the cup-like member 20 at which fissures are formed during gas ejection can be adjusted.

Particularly when the cup-like member 20 in this embodiment is formed of aluminum (A5052-H24), as an example of the numerical data pertaining thereto, the thickness Y of the side wall 23 portion and a base portion 25 is preferably between 0.7 and 1.5 mm, and the thickness X of the flange portion 22 (joining portion) is preferably between 1.3 and 2.0 mm. The thickness ratio X/Y of the side wall 23 portion and base portion 25 to the flange portion 22 is preferably regulated within the range of 1.3 to 1.9.

When the gas generator 1 formed as shown in FIG. 1 is activated, the slit portion 24 serving as a fragile portion fissures first, and gas for activating a drive portion (a device such as a piston for driving a winding mechanism of a seat belt or the like) of a pretensioner is discharged from the fissured part. After the gas generator 1 is activated in this manner, or in other words after the slits 24 are fissured, the cup-like member 20 takes the form shown in FIG. 2. As shown in FIG. 2, even though the cup-like member 20 fissures in the axial direction from the slit portions 24, the fractures do not extend to the thicker flange portion 22.

If a flange portion 22′ (joining portion) is formed with the same thickness as a remaining sidewall portion 23′, as shown in the perspective view in FIG. 3 showing the fissuring condition of the cup-like member, fractures caused by the fissuring of slit portions 24′ formed in the cup-like member as shown in FIG. 3(A) reach the flange portion 22′, as shown in FIG. 3(B), causing the fractured flange portion 22′ to dislocate from the crimped portion of an igniter collar member 10′ as shown in FIG. 3(C). As a result, the cup-like member 20′ itself becomes entirely dislocated from an igniter assembly 40′ (in other words the igniter collar member 10′), and is propelled into flight by the surplus gas pressure. When the cup-like member 20, or fragments thereof, is propelled into flight, a gas flow part leading to a drive portion (a piston or the like) for driving the winding mechanism of a seat belt or the like in the pretensioner may be blocked to a certain extent, or a flying object may be trapped in a seat belt winding drive portion (a gear or the like), for example, thus hindering rotation of the gear so that an optimum operating performance cannot be obtained.

Therefore, increasing the thickness of a joining portion such as the flange portion 22 in the manner described in this embodiment, so that fissures in the joining portion can be avoided and flying or scattered fragments can be prevented, is important for ensuring the operational reliability of the pretensioner and so on.

1. A gas generator comprising an igniter assembly in which an igniter functioning as an activation starting means is held by an igniter collar member, a gas generating agent which generates a gas when ignited by an activation of the igniter, and a cup-like member in a cylindrical form with one closed end, in which the gas generating agent is accommodated,
wherein a joining portion to be joined to the igniter collar member in the igniter assembly is provided on an open side end portion of the cup-like member, the joining portion serving to integrate the cup-like member and igniter assembly, and
the thickness of the joining portion provided on the cup-like member is greater than the thickness of a side wall portion of the cup-like member.

2. The gas generator according to claim 1, wherein the joining portion is a flange portion formed by bending the open side end portion of the cup-like member.

3. The gas generator according to claim 2, wherein the flange portion of the cup-like member is fixed to the igniter collar member in the igniter assembly by crimping.

4. The gas generator according to claim 1, wherein a fragile portion, formed to be the weakest part of the wall portion of the cup-like member in relation to pressure or heat generated in the interior of the cup-like member, is provided in the side wall portion of the cup-like member.

5. The gas generator according to claim 4, wherein the fragile portion is a notch formed to extend in the axial direction of the cup-like member, and the notch is formed between the joining portion and a closed surface side end portion.

6. The gas generator according to claim 4 or 5, wherein the fragile portion is provided equally in a circumferential direction of the cup-like member.

7. The gas generator according to claim 1 or 2, wherein the thickness of the joining portion provided on the cup-like member is at least 1.3 times the thickness of the side wall portion of the cup-like member.
